(19) United States
(12) Patent Application Publication
(10) Pub. No.: US 2026/0242071 A1
(43) Pub. Date: Aug. 20, 2026

(54) Multimodal Magnetic Flux Engine for Spacecraft Propulsion

(71) Applicant: Overawe, LLC, Alice, TX (US)

(72) Inventor: Encarnacion GONZALEZ, Alice, TX (US)

(73) Assignee: Overawe, LLC, Alice, TX (US)

(21) Appl. No.: 19/055,417

(22) Filed: Feb. 17, 2025

(51) Int. Cl. B64G 1/40

(52) U.S. Cl. CPC B64G 1/413

(57) ABSTRACT

This invention utilizes a plurality of electromagnetic coils to create magnetic flux sequentially applied to a linear array of coils. These coils magnetically draw charged particles in, and accelerate the particles through, the linear array. The engine may be used in conjunction with an electromagnet. Both devices generate thrust in an ambient magnetic field.

### CROSS-REFERENCE TO RELATED APPLICATIONS

This application refers to U.S. Prov. Pat. App. No. 62/872,115 filed Jul. 9, 2019, U.S. patent application Ser. No. 16/912,801 filed Jun. 26, 2020, and U.S. Continuation-in-Part patent application Ser. No. 18/097,312 filed Jan. 16, 2023, all of which are included, in their entirety, by reference.

### FIELD OF THE INVENTION

This invention relates to spacecraft propulsion. As is scientifically well-known magnetic flux is a physical force (i.e. the Lorentz force and Ampere's force). This invention is based on a plurality of electromagnetic and/or plasma coils which create high pressure, magnetic flux directed through variable exhaust nozzles or a cone shaped coil to create thrust for spacecraft. In the first mode of operation, the high pressure, magnetic field lines created interact, or interoperate, with local, ambient magnetic field lines to create thrust. In the second mode of operation, ambient electrons or charged ions may be collected and magnetically accelerated though the invention, creating additional thrust. Both of these mechanisms may be additively combined. Also, either of these mechanisms may be selectively excluded when the engine operates. Also, these mechanisms may be selectively reversed in operating direction.

### BACKGROUND OF THE INVENTION

For many years extensive research has been done by private and government entities directed towards creating practical long-term infinite distance propulsion systems for spacecraft. Electromagnetic flux exists throughout the known universe. Accordingly, a spacecraft propulsion system that utilizes ambient or native electromagnetic fields by directing the magnetic flux created by an engine so that the two magnetic fields interact, or interoperate, with one another to create thrust is desirable. Also, a spacecraft propulsion system that channels ionic material in front of the engine forcibly through the engine creates additional thrust. These two methods of creating thrust may be additively combined when the engine is in operation. Also, these two mechanisms may be selectively reversed in operating direction.

### SUMMARY OF THE INVENTION

The present invention relates to spacecraft propulsion systems which utilize magnetic flux as a physical force to propel spacecraft through the vacuum of outer space. The system uses a plurality of coils of electrically conductive material, super conducting material, or plasma coils designed to create focused, directed electromagnetic flux fields. As a first mode of operation, the focused, directed magnetic flux field that is created by the present invention interacts with naturally occurring magnetic fields found in space to create propulsion. As a second mode of operation, the engine may be operated as an ion engine. In this second mode, the engine forcibly transfers ionic material in front of the engine through the engine, expelling the ionic material at the rear of the engine creating additional thrust. Both methods of creating thrust are additively combined to form the total thrust output of the engine. Also, these two mechanisms may be selectively reversed in operating direction.

The engine may be initially powered electrically by banks of capacitors or super capacitors. When in motion, the magnetic fields produced by the engine may interact with a plurality of coils to create electric power for the engine. Solar power, a nuclear reactor, a fusion reactor, or batteries may be used to optionally initially power the engine.

This invention utilizes a plurality of electromagnetic and/or plasma coils to produce high pressure, high velocity magnetic flux (via the Lorentz force and the Ampere force) to create thrust for spacecraft. The first method whereby thrust is created is by the relative motion of the electromagnetic and/or plasma coils inducing a magnetic field that moves in respect to a naturally occurring magnetic field. The second method whereby thrust is created is by electromagnetically attracting and unidirectionally propelling charged ionic matter located generally at the front (the input) of the engine along the generated magnetic field lines creating a volumetric coefficient of expansion which will be condensed and/or concentrated as the charged ionic matter travels through, and, out the back (or output) of the invention.

### BRIEF DESCRIPTION OF THE DRAWINGS

FIG. 1 shows a diagrammatic view of a magnetic flux engine for spacecraft propulsion. The diagram has been illustrated to show how the focused, directed magnetic flux field that is created by the magnetic flux engine interacts with naturally occurring magnetic fields found in space to create propulsion.

FIG. 1a shows the vector sum of all forces acting on the engine producing thrust when the magnetic flux field that is created by the magnetic flux engine interacts with naturally occurring magnetic fields found in space to create propulsion.

FIG. 2 shows a diagrammatic view of a magnetic flux engine for spacecraft propulsion. The diagram has been illustrated to show how electromagnetically attracting and unidirectionally propelling charged ionic matter located generally at the front (the input) of the engine along the generated magnetic field lines creates a volumetric coefficient of expansion which will be condensed and/or concentrated as the charged ionic matter travels through, and, out the back (or output) of the engine.

FIG. 2a shows the vector sum of all forces acting on the engine producing thrust when the engine electromagnetically attracts and unidirectionally propels charged ionic matter located generally at the front (the input) of the engine along the generated magnetic field lines creating a volumetric coefficient of expansion which will be condensed and/or concentrated as the charged ionic matter travels through, and, out the back (or output) of the invention

### DETAILED DESCRIPTION OF THE INVENTION

The invention is not limited to the embodiments shown. These only represent example variants of the current invention.

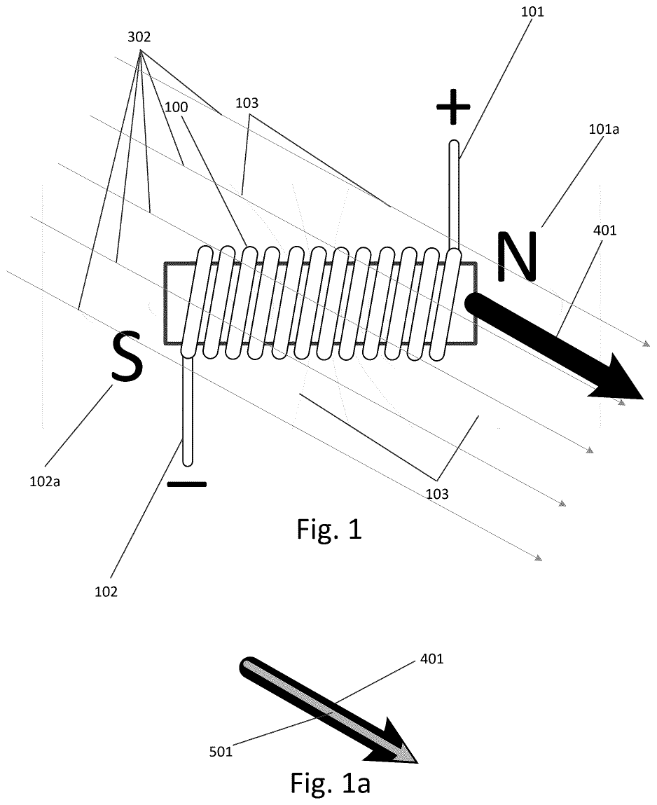

Turning now to FIG. 1, a first diagrammatic view of a magnetic flux engine for spacecraft propulsion is shown. The diagram has been illustrated to show how the focused, directed magnetic flux field 103 that is created by the magnetic flux engine interacts with naturally occurring magnetic fields 302 found in space to create propulsion.

The magnetic flux engine uses a plurality of coils of electrically conductive material, super conducting material, or plasma coils designed to create a high density, high magnetic flux field 103. The multiplicity of coils of electrically conductive material, super conducting material, or plasma coils are represented diagrammatically as electromagnet 100. Electromagnet 100 has a positive electrical supply 101 and a negative electrical supply 102 generating, respectively, a north (“N”) magnetic pole 101a and a south (“S”) magnetic pole 102a. The electromagnet 100 generates a magnetic flux field 103 with field lines as illustrated in the diagram.

An external magnetic field 302 exists in the vicinity of electromagnet 100. Thus, when energized, electromagnet 100 will travel along the field lines of magnetic field 302 as indicated by vector 401.

Those having skill in the art will recognize that when energized in the opposite manner, wherein electromagnet 100 has a negative electrical supply (at 102) generating a south (“S”) magnetic pole (at 102a) and a positive electrical supply (at 101) generating a north (“N”) magnetic pole (at 101a) at opposite locations from those shown in FIG. 1, that electromagnet 100 will travel along the field lines of magnetic field 302 opposite the direction indicated by vector 401.

Turning now to FIGS. 1 and 1a, a vector map showing the sum of the forces acting on a spacecraft equipped with electromagnet 100 traveling in space is added. In this example, electromagnet 100 is propelled as indicated by thrust vector 401. Since thrust vector 401 is the only force acting on electromagnet 100, the spacecraft in which electromagnet 100 is installed travels as indicated by thrust vector 501. Thrust vector 501 is the vector sum of the only vector force (thrust vector 401) being applied to electromagnet 100.

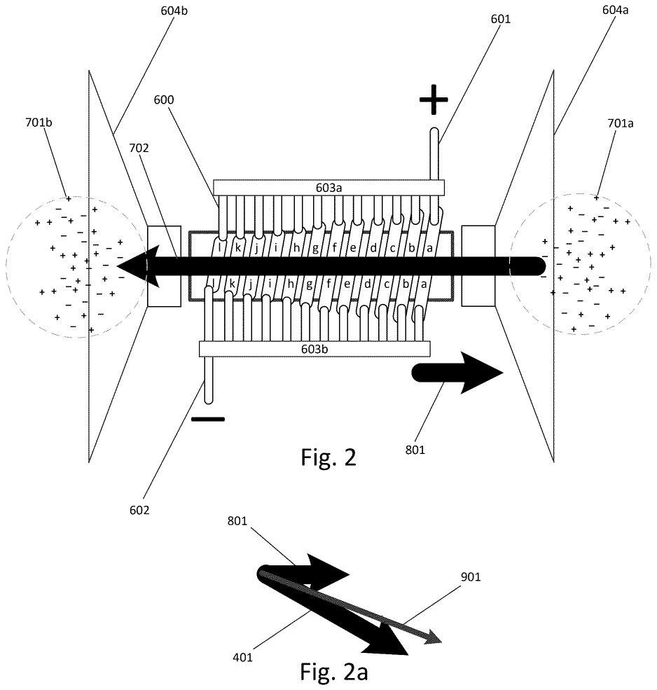

Turning now to FIG. 2, a second diagrammatic view of a magnetic flux engine 600 for spacecraft propulsion is shown. The diagram has been illustrated to show how an oscillating magnetic flux field that is created by the magnetic flux engine 600 interacts with naturally occurring negatively and positively charged particles to create thrust. Also, the diagram shows a mechanical funnel collector 604a positioned in front of (to the right of) the input side of the magnetic flux engine 600. The mechanical funnel collector 604a increases the area of space swept to collect charged particles for injection into the magnetic flux engine 600. Also, the diagram shows a mechanical funnel collector 604b positioned in rear of (to the left of) the output side of the magnetic flux engine 600. The mechanical funnel collector 604b increases the area of space swept to collect charged particles for injection into the magnetic flux engine 600 when the electrical charge supplied to the magnetic flux engine 600 (i.e. the positive electrical sequencer 603a and negative electrical sequencer 603b) is reversed.

The magnetic flux engine 600 uses a multiplicity of rings (a through l) of electrically conductive material, super conducting material, or individual plasma coils to create a series of high magnetic flux fields that are sequentially transposed right to left in direction 702. Ordinarily, the rings a through l decrease in radius. In other words, ring a has a larger radius than ring l. By this means, as negatively and positively charged particles are drawn into and through magnetic flux engine 600 they are volumetrically condensed as they travel through the magnetic flux engine 600. Magnetic flux engine 600 has a positive electrical supply 601 and a negative electrical supply 602 supplied, respectively, to positive electrical sequencer 603a and negative electrical sequencer 603b. Positive electrical sequencer 603a and negative electrical sequencer 603b supply positive and negative electrical current, sequentially, in a linear sequence, to rings a through l generating a north “N” magnetic pole and a south “S” magnetic pole sequentially in each ring, a through l. As each ring is energized in sequence it draws negatively and positively charged particles 701a along in direction 702. By this means, negatively and positively charged electrical particles are accelerated through ring a, though intervening rings b through k, and ejected through ring l. By this means, a volumetric transfer and condensation of negatively and positively charged particles 701a occurs, generating a thrust 801 to the right.

The thrust generated by the magnetic flux engine 600 is determined by the mass of negatively and positively charged particles 701a drawn into and through the magnetic flux engine 600. Ordinarily, there are approximately three hydrogen nuclei in a cubic meter of space in a vacuum. Therefore, some method of concentrating and condensing the number of hydrogen nuclei collected to provide greater mass to provide greater thrust is necessary. These devices would be affixed on the input side of the magnetic flux engine 600 and may include: 1) A mechanical funnel collector 604a; 2) An electrically charged mechanical funnel collector; 3) Electrically charged rings in the form of a funnel; 4) An electrical field generator; or, 5) Any combination of the foregoing.

Turning now to FIGS. 1, 1a, 2, and 2a, a vector sum 901 of vector forces generated by both electromagnet 100 and magnetic flux engine 600 is shown. In this example, electromagnet 100, as shown in FIG. 1, is propelled as shown by thrust vector 401. Magnetic flux engine 600, as shown in FIG. 2, is propelled as shown by thrust vector 801. The vector sum of these two vectors (thrust vector 401 and thrust vector 801) as shown in FIG. 2a is thrust vector 901. Thus, a spacecraft with an electromagnet 100 and a magnetic flux engine 600 installed generating thrust vectors 401 and 801, respectively, moves in the direction as indicated by thrust vector 901.

In a situation where there is no ambient magnetic field and therefore electromagnet 100 does not create thrust, magnetic flux engine 600 may still create thrust. Also, it will be readily understood that reversing the polarity of the electrical current supplied to both the electromagnet 100 and the magnetic flux engine 600 reverses the direction of the produced thrust. Thus, the direction of thrust generated by both thrust vector 401 and thrust vector 801 is reversed (as is their sum 901). In cases where the polarity of electrical current supplied to the magnetic flux engine 600 is reversed, mechanical funnel collector 604b, installed at the output end of (to the left of) the output side of the magnetic flux engine 600 increases the area of space swept to collect charged particles for injection into the magnetic flux engine 600.

The electromagnet 100 is preferably installed in a craft where it disturbs the disposition of negatively and positively charged particles 701a and 701b as little as possible relative to the input and output of the magnetic flux engine 600. Configurations where the input(s) of magnetic flux engine(s) 600 is/are physically separated from electromagnet(s) 100 is/are preferred and will ensure best performance of both systems when they are installed and activated at the same time. For example, the input of the magnetic flux engine(s) 600 may be in front of the electromagnet(s) 100 when the two engines are arranged linearly.

What is claimed:

1. A spacecraft propulsion system comprised of:
a) a magnetic flux engine, wherein:
i. the magnetic flux engine comprising a linearly aligned series of electromagnetic rings;
ii. wherein each electromagnetic ring is connected on one side to a positive electrical sequencer and on its opposite side to a negative electrical sequencer;
iii. wherein the positive electrical sequencer is attached to a positive voltage supply;
iv. wherein the negative electrical sequencer is attached to a negative voltage supply;
v. wherein each electromagnetic ring is electrified, in a linear sequence, by both its attached positive electrical sequencer and its attached negative electrical sequencer;
vi. wherein charged atomic particles are drawn into one end of the magnetic flux engine and rapidly expelled from the opposite end of the magnetic flux engine.

2. A spacecraft propulsion system of claim 1 wherein the volume of space swept to capture ionic material is increased by the addition of a funnel collector affixed to the input of the engine.

3. A spacecraft propulsion system of claim 1 wherein the volume of space swept to capture ionic material is increased by the addition of an electrically charged funnel collector affixed to the input of the engine.

4. A spacecraft propulsion system of claim 1 wherein the volume of space swept to capture ionic material is increased by the addition of electrically charged rings in the form of a funnel affixed to the input of the engine.

5. A spacecraft propulsion system of claim 1 wherein the volume of space swept to capture ionic material is increased by the addition of an electrical field generator affixed to the input of the engine.

6. A spacecraft propulsion system of claim 1 wherein the direction of thrust may be reversed by reversing the polarity of the electrical current supplied to the positive electrical sequencer and the negative electrical sequencer.

7. A spacecraft propulsion system of claim 6 wherein the volume of space swept to capture ionic material is increased by the addition of a funnel collector affixed to the output of the engine.

8. A spacecraft propulsion system of claim 6 wherein the volume of space swept to capture ionic material is increased by the addition of an electrically charged funnel collector affixed to the input of the engine.

9. A spacecraft propulsion system of claim 6 wherein the volume of space swept to capture ionic material is increased by the addition of electrically charged rings in the form of a funnel affixed to the input of the engine.

10. A spacecraft propulsion system of claim 6 wherein the volume of space swept to capture ionic material is increased by the addition of an electrical field generator affixed to the input of the engine.

11. A spacecraft propulsion system of claim 1 comprising an electromagnet and a magnetic flux engine wherein the magnetic flux engine is physically separated from the electromagnet.

12. A spacecraft propulsion system of claim 1 comprising an electromagnet and a magnetic flux engine wherein the magnetic flux engine is located in front of the electromagnet.

13. A spacecraft propulsion system of claim 6 comprising an electromagnet and a magnetic flux engine with funnel collectors affixed at one end.

14. A spacecraft propulsion system of claim 6 comprising an electromagnet and a magnetic flux engine with funnel collectors affixed at both ends.
